(19) United States
(12) Patent Application Publication
(10) Pub. No.: US 2019/0171014 A1
(43) Pub. Date: Jun. 6, 2019

(54) Vehicular Head-Up Display Using Holographic Element

(71) Applicant: Mega 1 Company Limited, New Taipei City (TW)

(72) Inventors: Chi-Wei Chen, New Taipei City (TW); Wei-Chih Lin, New Taipei City (TW)

(21) Appl. No.: 16/180,095

(22) Filed: Nov. 5, 2018

(30) Foreign Application Priority Data
Dec. 1, 2017 (TW) 106142264

(51) Int. Cl. G02B 27/01; G02B 27/28; G02B 27/14

(52) U.S. Cl. CPC G02B 27/0172; G02B 27/149; G02B 27/0101; G02B 27/281

(57) ABSTRACT

A vehicular head-up display disposed in a vehicle includes an image forming unit, a reflection mirror, and a holographic mirror. The image forming unit disposed on a roof of the vehicle employs light sources. The reflection mirror disposed below a windshield in the front of the vehicle has a first reflection surface facing forward and upward. The holographic mirror disposed between the reflection mirror and the windshield has a second reflection surface facing backward. The holographic mirror reflects light rays of a specific wavelength band and allows light rays of not the specific wavelength band to pass through. Light rays emitted by the image forming unit are reflected by the first and second reflection surfaces, and then the light rays of the specific wavelength band reflected from the second reflection surface are projected onto the windshield to form a virtual image in front of the windshield.

### BACKGROUND OF THE INVENTION

### 1. Field of the Invention

The present invention relates to a vehicular head-up display and, more particularly, to a vehicular head-up display using a holographic element.

### 2. Description of the Prior Art

Referring to FIG. 1, there is shown a schematic view of a conventional vehicular head-up display 1. The vehicular head-up display 1 is disposed in a vehicle 2 and includes an image forming unit 11 and a reflection mirror 12. The image forming unit 11 is used for generating a real image; the reflection mirror 12 is used for optically reflecting and/or amplifying the real image generated by the image forming unit 11. The image forming unit 11 and the reflection mirror 12 employ a discrete design. Specifically, the image forming unit 11 is disposed on a roof 21 of the vehicle 2. The reflection mirror 12 is disposed below a windshield 22 in the front of the vehicle 2. The reflection mirror 12 has a reflection surface 121 facing backward and upward with respect to the vehicle 2; in the embodiment, the reflection surface 121 faces backward and upward with respect to the vehicle 2 at an angle of 30 degrees from the horizontal. Light rays emitted by the image forming unit 11 are projected onto the reflection surface 121 of the reflection mirror 12; light rays reflected from the reflection surface 121 of the reflection mirror 12 are projected onto the windshield 22; and light rays reflected from the windshield 22 are projected onto a user's eyes E1 so that the user sees a virtual image P1 formed in front of the windshield 22, in which the user may be a driver or a passenger. The virtual image P1 is formed within the driver's field of view while driving so that the driver may pay attention to road conditions and acquire driving information from the virtual image P1 at the same time.

However, as shown in FIG. 2, because the reflection surface 121 of the reflection mirror 12 of the vehicular head-up display 1 faces backward and upward with respect to the vehicle 2, light rays which come from ambient light such as sunlight at some specific angles in some specific directions have chance to be introduced by the reflection surface 121 of the reflection mirror 12 to enter the vehicle 2 to project onto the user's eyes E1, resulting in the user's discomfort or even bad effects on driving safety.

### SUMMARY OF THE INVENTION

The present invention is adapted to providing a vehicular head-up display using a holographic element to solve the problem of the reflection mirror introducing ambient light to enter the vehicle to project onto the user's eyes.

According to an aspect of the present invention, there is provided a vehicular head-up display using a holographic element. The vehicular head-up display is disposed in a vehicle and includes an image forming unit, a reflection mirror, and a holographic mirror. The image forming unit is disposed on a roof of the vehicle and employs light sources, The reflection mirror is disposed below a windshield in the front of the vehicle. The reflection mirror has a first reflection surface facing forward and upward with respect to the vehicle. The holographic mirror is disposed between the reflection mirror and the windshield. The holographic mirror has a second reflection surface facing backward with respect to the vehicle. The holographic mirror reflects light rays of a specific wavelength band and allows light rays of not the specific wavelength band to pass through. Light rays emitted by the image forming unit are projected onto the first reflection surface of the reflection mirror; light rays reflected from the first reflection surface of the reflection mirror are projected onto the second reflection surface of the holographic mirror; and the light rays of the specific wavelength band reflected from the second reflection surface of the holographic mirror are projected onto the windshield to form a virtual image in front of the windshield.

According to another aspect of the present invention, the light sources include a red light source, a green light source, and a blue light source. The specific wavelength band includes a wavelength band corresponding to the green light source.

According to another aspect of the present invention, the first reflection surface of the reflection mirror is a flat surface or a curved surface.

According to another aspect of the present invention, the second reflection surface of the holographic mirror is a flat surface or a curved surface.

According to another aspect of the present invention, the holographic mirror includes a light transmitting substrate and a holographic film disposed on the light transmitting substrate.

According to an aspect of the present invention, there is further provided a vehicular head-up display using a holographic element. The vehicular head-up display is disposed in a vehicle and includes an image forming unit and a holographic mirror. The image forming unit is disposed on a roof of the vehicle and employs light sources. The holographic mirror is disposed below a windshield in the front of the vehicle. The holographic mirror reflects light rays of a specific wavelength band and allows light rays of not the specific wavelength band to pass through. Light rays emitted by the image forming unit are projected onto a reflection surface of the holographic mirror; the light rays of the specific wavelength band reflected from the holographic mirror are projected onto the windshield to form a virtual image in front of the windshield.

According to another aspect of the present invention, the light sources include a red light source, a green light source, and a blue light source. The specific wavelength band includes a wavelength band corresponding to the green light source.

According to another aspect of the present invention, the reflection surface of the holographic mirror is a flat surface or a curved surface.

According to another aspect of the present invention, the holographic mirror includes a light transmitting substrate and a holographic film disposed on the light transmitting substrate.

The above and other objectives, features, and advantages of the present invention will be better understood from the following detailed description of the preferred embodiments of the present invention that are illustrated in the accompanying drawings.

### BRIEF DESCRIPTION OF THE DRAWINGS

FIG. 1 is a schematic view of a conventional vehicular head-up display;

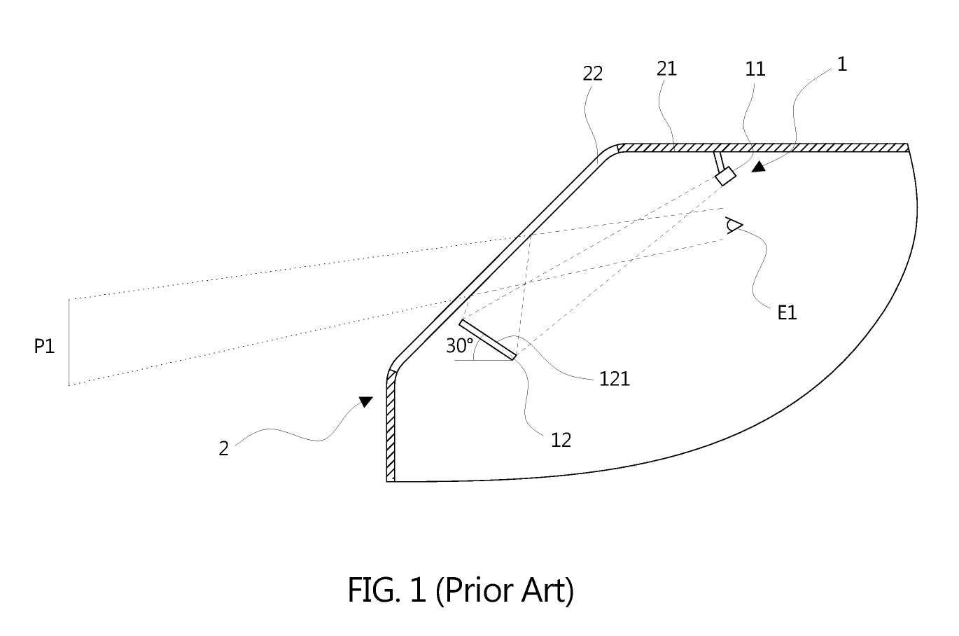

FIG. 2 is a schematic view of ambient light affecting the vehicular head-up display as shown in FIG. 1;

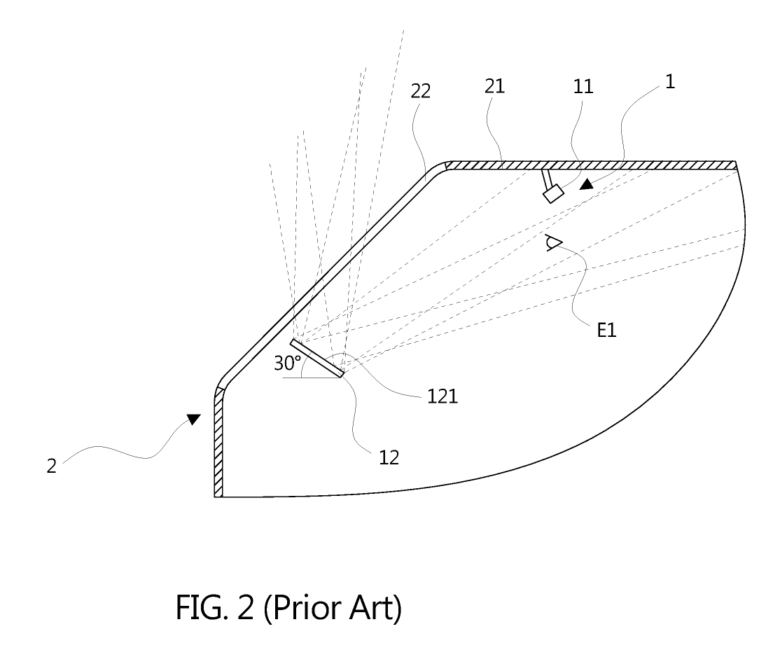

FIG. 3 is a schematic view of a vehicular head-up display according to a first embodiment of the present invention;

FIG. 4 is a schematic view of ambient light affecting the vehicular head-up display as shown in FIG. 3;

FIG. 5 is a schematic view of a vehicular head-up display according to a second embodiment of the present invention; and

FIG. 6 is a schematic view of a holographic mirror according to an embodiment of the present invention.

### DESCRIPTION OF THE PREFERRED EMBODIMENTS

In the following embodiments, same or similar reference numerals are used in the drawings and the description to refer to the same or like components. Moreover, directional terms, such as up, down, left, right, front, and back are used with respect to the drawings. These and similar directional terms should not be construed to limit the scope of the present invention in any manner.

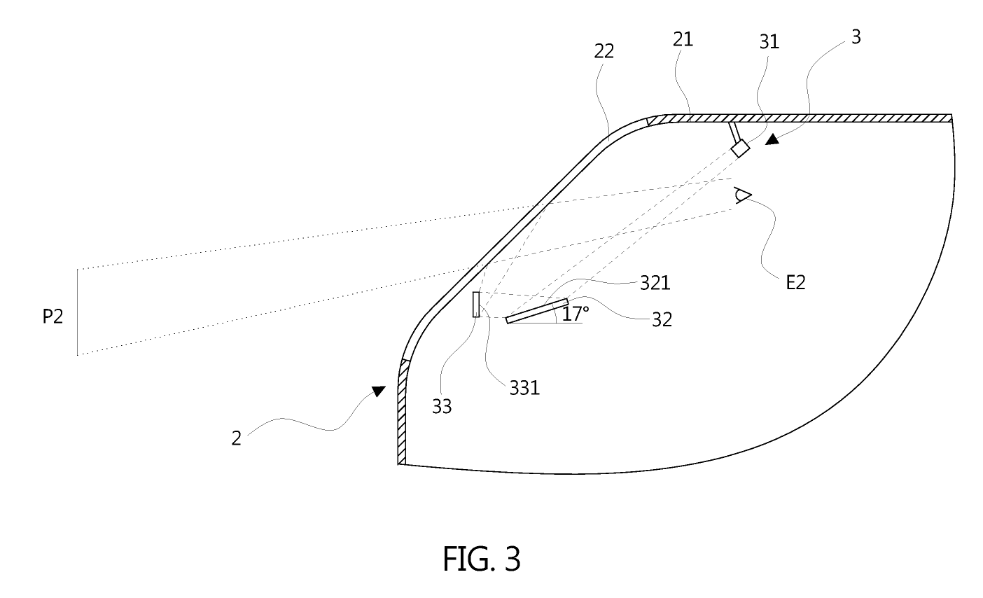

Referring to FIG. 3, there is shown a schematic view of a vehicular head-up display 3 according to a first embodiment of the present invention. The vehicular head-up display 3 is disposed in a vehicle 2 and includes an image forming unit 31, a reflection mirror 32, and a holographic mirror 33. The image forming unit 31 is used for generating a real image; the reflection mirror 32 and the holographic mirror 33 are used for optically reflecting and/or amplifying the real image generated by the image forming unit 31. The image forming unit 31, the reflection mirror 32, and the holographic mirror 33 employ a discrete design. Specifically, the image forming unit 31 is disposed on a roof 21 of the vehicle 2. The reflection mirror 32 is disposed below a windshield 22 in the front of the vehicle 2. The reflection mirror 32 has a first reflection surface 321 facing forward and upward with respect to the vehicle 2; in the embodiment, the first reflection surface 321 faces forward and upward with respect to the vehicle 2 at an angle of 17 degrees from the horizontal. The holographic mirror 33 is disposed between the reflection mirror 32 and the windshield 22. The holographic mirror 33 has a second reflection surface 331 facing backward with respect to the vehicle 2; in the embodiment, the second reflection surface 331 faces backward with respect to the vehicle 2 at an angle of about 90 degrees from the horizontal. In an embodiment, the first reflection surface 321 and/or the second reflection surface 331 may be a curved surface capable of refocusing the real image from the image forming unit 31, but it is not limited thereto. For example, the first reflection surface 321 and/or the second reflection surface 331 may be a flat surface.

Light rays emitted by the image forming unit 31 are projected onto the first reflection surface 321 of the reflection mirror 32; light rays reflected from the first reflection surface 321 of the reflection mirror 32 are projected onto the second reflection surface 331 of the holographic mirror 33; light rays reflected from the second reflection surface 331 of the holographic mirror 33 are projected onto the windshield 22; and light rays reflected from the windshield 22 are projected onto a user's eyes E2 so that the user sees a virtual image P2 formed in front of the windshield 22, in which the user may be a driver or a passenger. The virtual image P2 is formed within the driver's field of view while driving so that the driver may pay attention to road conditions and acquire driving information from the virtual image P2 at the same time.

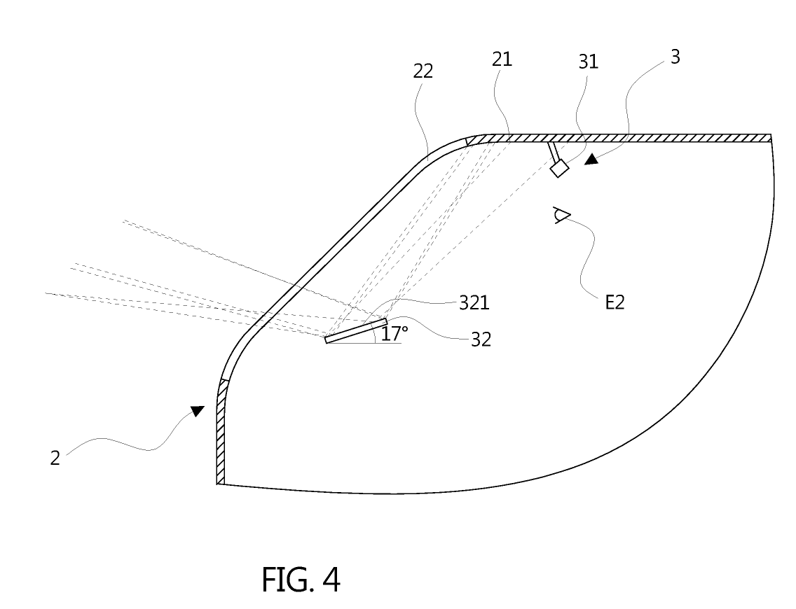

As shown in FIG. 4 with omitting the holographic mirror 33, although light rays which come from ambient light such as sunlight at some specific angles in some specific directions have chance to be introduced by the first reflection surface 321 of the reflection mirror 32 to enter the vehicle 2, the light rays which enter the vehicle 2 are projected in front of the user's eyes E2 because the first reflection face 321 of the reflection mirror 32 faces forward and upward with respect to the vehicle 2. Therefore, the light rays which enter the vehicle 2 through the reflection mirror 32 are not projected onto the user's eyes E2 so that it does not result in the user's discomfort or bad effects on driving safety.

In addition, the holographic mirror 33 may reflect light rays of a specific wavelength band and allow light rays of not the specific wavelength band to pass through. Therefore, the holographic mirror 33 may be designed to let light rays of unwanted wavelength bands to pass through so that the light rays of unwanted wavelength bands are not projected onto the windshield 22 thereby increasing the display quality of the virtual image P2. For example, if the image forming unit 31 employs a red light source with a wavelength band of 630-650 nm, a green light source with a wavelength band of 510-530 nm, and a blue light source with a wavelength band of 440-460 nm to combine color images, the holographic mirror 33 may be designed to reflect light rays of a wavelength band of 510-530 nm (corresponding the green light source) and let light rays of other wavelength bands to pass through. It is noted that the wavelength band of 510-530 nm corresponding to the green light source is the specific wavelength band. Moreover, the holographic mirror 33 may be designed with the angle of incidence unequal to the angle of reflection whereby the disposition positions and angles of the image forming unit 31, the reflection mirror 32, and the holographic mirror 33 have more flexible designs. But it is not limited the present invention, for example, the holographic mirror 33 may be designed with the angle of incidence equal to the angle of reflection.

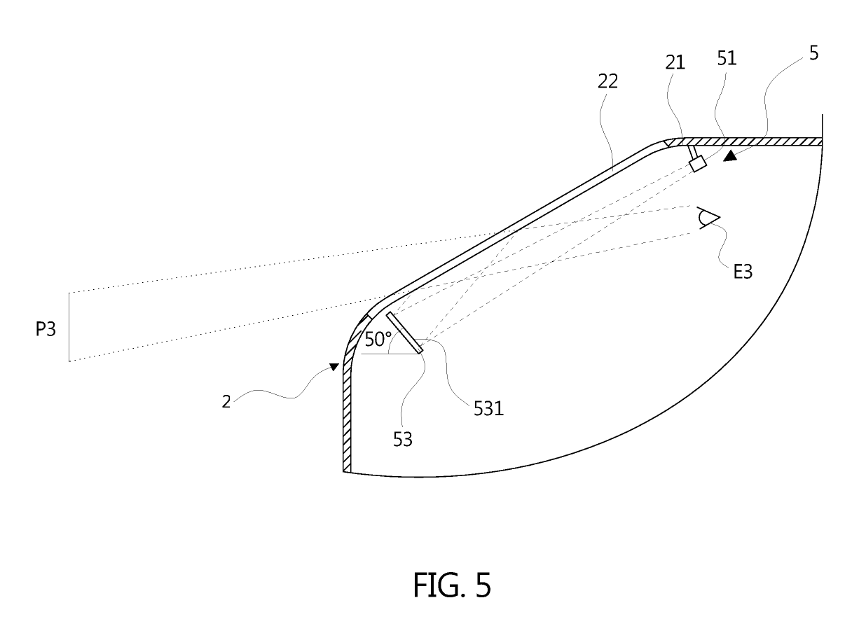

Referring to FIG. 5, there is shown a schematic view of a vehicular head-up display 5 according to a second embodiment of the present invention. The vehicular head-up display 5 is disposed in a vehicle 2 and includes an image forming unit 51 and a holographic mirror 53. The image forming unit 51 is used for generating a real image; the holographic mirror 53 is used for optically reflecting and/or amplifying the real image generated by the image forming unit 51. The image forming unit 51 and the holographic mirror 53 employ a discrete design. Specifically, the image forming unit 51 is disposed on a roof 21 of the vehicle 2. The holographic mirror 53 is disposed below a windshield 22 in the front of the vehicle 2; in the embodiment, the holographic mirror 53 has a reflection surface 531 facing backward and upward with respect to the vehicle 2 at an angle of 50 degrees from the horizontal. In an embodiment, the reflection surface 531 may be a flat surface or a curved surface. Light rays emitted by the image forming unit 51 are projected onto the reflection surface 531 of the holographic mirror 53; light rays reflected from the reflection surface 531 of the holographic mirror 53 are projected onto the windshield 22; and light rays reflected from the windshield 22 are projected onto a user's eyes E3 so that the user sees a virtual image P3 formed in front of the windshield 22, in which the user may be a driver or a passenger. The virtual image P3 is formed within the driver's field of view while driving so that the driver may pay attention to road conditions and acquire driving information from the virtual image P3 at the same time.

The holographic mirror 53 may reflect light rays of a specific wavelength band and allow light rays of not the specific wavelength band to pass through. Therefore, the holographic mirror 53 may be designed to let light rays of unwanted wavelength bands to pass through so that the light rays of unwanted wavelength bands are not projected onto the windshield 22 thereby increasing the display quality of the virtual image P3. For example, if the image forming unit 51 employs a red light source with a wavelength band of 630-650 nm, a green light source with a wavelength band of 510-530 nm, and a blue light source with a wavelength band of 440-460 nm to combine color images, the holographic mirror 53 may be designed to reflect light rays of a wavelength band of 510-530 nm (corresponding the green light source) and let light rays of other wavelength bands to pass through. It is noted that the wavelength band of 510-530 nm corresponding to the green light source is the specific wavelength band. Light rays of not the specific wavelength band which come from ambient light such as sunlight pass through the holographic mirror 53 so that most of the light rays which come from ambient light do not enter the vehicle 2 through the holographic mirror 53 to project onto the user's eyes E3 so that it does not result in the user's discomfort or bad effects on driving safety. Moreover, the holographic mirror 53 may be designed with the angle of incidence unequal to the angle of reflection whereby the disposition positions and angles of the image forming unit 51 and the holographic mirror 53 have more flexible designs. Even the reflection surface 531 of the holographic mirror 53 may be horizontal. Compared to the holographic mirror 33 in the first embodiment, the holographic mirror 53 have more flexible disposition. But it is not limited to the present invention; for example, the holographic mirror 53 may be designed with the angle of incidence equal to the angle of reflection.

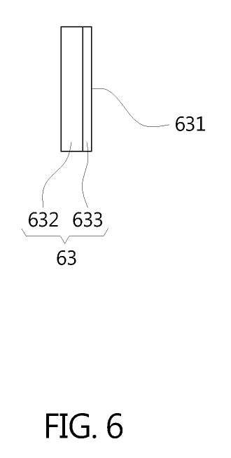

Referring to FIG. 6, there is shown a schematic view of a holographic mirror 63 according to an embodiment of the present invention. The holographic mirror 63 includes a light transmitting substrate 632 and a holographic film 633 with microstructures. The holographic film 633 is disposed on the light transmitting substrate 632, and a surface of the holographic film 633 away from the light transmitting substrate 632 is taken as a reflection surface 631 of the holographic mirror 63. In an embodiment, the light transmitting substrate 632 may be made of glass, plastic or other material. Alternatively, the holographic mirror may be implemented by directly forming optical structures on a surface of the light transmitting substrate without using the holographic film. The holographic mirror 63 may be applied to the holographic mirror 33 or 53 as shown in FIG. 3 to FIG. 5.

Although the present invention has been described in terms of the preferred embodiments, it is not limited thereto. It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. A vehicular head-up display using a holographic element, disposed in a vehicle, comprising:
an image forming unit disposed on a roof of the vehicle, the image forming unit employing a plurality of light sources;
a reflection mirror disposed below a windshield in the front of the vehicle, the reflection mirror having a first reflection surface facing forward and upward with respect to the vehicle; and
a holographic mirror disposed between the reflection mirror and the windshield, the holographic mirror having a second reflection surface facing backward with respect to the vehicle, the holographic mirror reflecting light rays of a specific wavelength band and allowing light rays of not the specific wavelength band to pass through;
wherein light rays emitted by the image forming unit are projected onto the first reflection surface of the reflection mirror; light rays reflected from the first reflection surface of the reflection mirror are projected onto the second reflection surface of the holographic mirror; and the light rays of the specific wavelength band reflected from the second reflection surface of the holographic mirror are projected onto the windshield to form a virtual image in front of the windshield.

2. The vehicular head-up display of claim 1, wherein the plurality of light sources comprises a red light source, a green light source, and a blue light source, wherein the specific wavelength band comprises a wavelength band corresponding to the green light source.

3. The vehicular head-up display of claim 1, wherein the first reflection surface of the reflection mirror is a flat surface or a curved surface.

4. The vehicular head-up display of claim 1, wherein the second reflection surface of the holographic mirror is a flat surface or a curved surface.

5. The vehicular head-up display of claim 1, wherein the holographic mirror comprises a light transmitting substrate and a holographic film disposed on the light transmitting substrate.

6. A vehicular head-up display using a holographic element, disposed in a vehicle, comprising:
an image forming unit disposed on a roof of the vehicle, the image forming unit employing a plurality of light sources; and
a holographic mirror disposed below a windshield in the front of the vehicle, the holographic mirror reflecting light rays of a specific wavelength band and allowing light rays of not the specific wavelength band to pass through;
wherein light rays emitted by the image forming unit are projected onto a reflection surface of the holographic mirror; the light rays of the specific wavelength band reflected from the reflection surface of the holographic mirror are projected onto the windshield to form a virtual image in front of the windshield.

7. The vehicular head-up display of claim 6, wherein the plurality of light sources comprises a red light source, a green light source, and a blue light source, wherein the specific wavelength band comprises a wavelength band corresponding to the green light source.

8. The vehicular head-up display of claim 6, wherein the reflection surface of the holographic mirror is a flat surface or a curved surface.

9. The vehicular head-up display of claim 6, wherein the holographic mirror comprises a light transmitting substrate and a holographic film disposed on the light transmitting substrate.
